(19) United States
(12) Patent Application Publication
(10) Pub. No.: US 2020/0249064 A1
(43) Pub. Date: Aug. 6, 2020

(54) PARTICULATE MATTER SUPPLY DEVICE

(71) Applicant: KAWASAKI JUKOGYO KABUSHIKI KAISHA, Kobe-shi, Hyogo (JP)

(72) Inventors: Yukio IWASAKI, Kobe-shi (JP); Ippei NAGAHIRO, Kobe-shi (JP); Masashi MISAWA, Kakogawa-shi (JP); Kyo DAN, Akashi-shi (JP)

(73) Assignee: KAWASAKI JUKOGYO KABUSHIKI KAISHA, Kobe-shi, Hyogo (JP)

(21) Appl. No.: 16/605,490

(22) PCT Filed: Apr. 13, 2018
(86) PCT No.: PCT/JP2018/015492

§ 371 Date: Oct. 15, 2019

(30) Foreign Application Priority Data
Apr. 14, 2017 (JP) 2017-080820

(51) Int. Cl. G01F 11/40; B25J 18/00

(52) U.S. Cl. CPC G01F 11/40; A23P 20/12; B25J 18/00

(57) ABSTRACT

A particulate matter supply device having a simple configuration, which includes: a fixing plate through which a flow path that allows passage of particulate matter penetrates; a bottom portion through which a discharge port that allows passage of particulate matter penetrates; and a movable portion between the fixing plate and the bottom portion, has an accommodation region capable of accommodating particulate matter in the accommodation region and penetrating the movable portion along a facing direction in which the fixing plate and the bottom portion face each other, and is movable to a position where the accommodation region communicates with the flow path and to a position where the accommodation region communicates with the discharge port. The fixing plate is provided with a level-off portion that, when the movable portion moves, levels off particulate matter so as to remove an amount of particulate matter exceeding a capacity of the accommodation region.

### TECHNICAL FIELD

The present invention relates to a particulate matter supply device that supplies particulate matter to a predetermined position.

### BACKGROUND ART

Conventionally, a particulate matter supply device for supplying predetermined amounts of particulate matter has been used. PTL 1 discloses one example of such a particulate matter supply device. PTL 1 discloses a particulate matter supply device that supplies particulate matter in a predetermined region, levels off to scrape and remove the particulate matter overflowed from the predetermined region and supplied to a position higher than the predetermined region, and thereby supplies predetermined amounts of the particulate matter accommodated in the predetermined region. In the particulate matter supply device of PTL 1, a configuration is disclosed in which a member for scraping and removing the particulate matter overflowed from the predetermined region and supplied to a position higher than the predetermined region is capable of partially moving rotationally and reciprocating by rotating in forward and reverse directions.

### CITATION LIST

### Patent Literature

PTL 1: JP 2007-075883 A

### SUMMARY OF INVENTION

### Technical Problem

However, in the particulate matter supply device disclosed in PTL 1, the particulate matter overflowed from the predetermined region and supplied to a position higher than the predetermined region is leveled off and removed, and the particulate matter accommodated in the predetermined region is moved to the next supply position together with the member for partitioning the predetermined region. Hence, both a driver for moving a member for scraping off the particulate matter overflowed from the predetermined region and supplied to a position higher than the predetermined region and a driver for moving the member for partitioning the predetermined region are required. Hence, the number of drivers for moving members is increased, the configuration of the device becomes complex, and the manufacturing cost for manufacturing the device for supplying particulate matter may be increased.

In view of the above-mentioned circumstances, an objective of the present invention is to provide a particulate matter supply device having a simple configuration.

### Solution to Problem

A particulate matter supply device of the present invention includes: a first member through which a first flow path that allows passage of particulate matter penetrates; a second member through which a second flow path that allows passage of particulate matter penetrates; and a movable member that is disposed between the first member and the second member, has an accommodation region capable of accommodating particulate matter therein and penetrating the movable member along a facing direction in which the first member and the second member face each other, and is movable to a first position where the accommodation region communicates with the first flow path and to a second position where the accommodation region communicates with the second flow path, and is characterized in that the first member is provided with a level-off portion that, when the movable member moves from the first position to the second position, levels off particulate matter so as to remove an amount of particulate matter exceeding a capacity of the accommodation region from the accommodation region.

In the particulate matter supply device of the above configuration, both of the movement of particulate matter for leveling off the particulate matter and the movement of particulate matter to the second flow path can be performed only by moving the movable member. As a result, the number of members to be moved can be reduced, and the configuration of the particulate matter supply device can be simplified.

Additionally, the movable member may be capable of reciprocating between the first position and the second position.

By reciprocating the movable member between the first position and the second position, it is possible to continuously discharge the particulate matter from the second flow path after leveling off.

The movable member may move from the first position to the second position by moving rotationally between the first member and the second member.

Since the movable member moves from the first position to the second position by rotational movement, the range in which the movable member moves can be reduced, and the configuration of the device can be downsized.

Additionally, the movable member may move from the first position to the second position by moving linearly between the first member and the second member.

Since the movable member moves from the first position to the second position by linear movement, the configuration of the device can be simplified and the device can be downsized.

Additionally, the first member may be attached to the inside of the first container portion, the second member may form a bottom portion of the first container portion, and the movable member may be disposed between the first member and the second member inside the first container portion.

Since the first member, the second member and the movable member are stored in the container portion, the configuration of the device can be downsized.

Additionally, a shaft portion that passes through the first container portion and is attached to the movable member may further be included, and rotation of the shaft portion about a central axis inside the first container portion may cause the movable member to move rotationally between the first member and the second member, and move the movable member from the first position to the second position.

Since the shaft portion for moving the movable member rotationally is disposed through the inside of the first container portion, the configuration of the device can be downsized.

Additionally, a first driver that rotates the shaft portion about the central axis may further be included, and the first driver may rotate the shaft portion in forward and reverse directions to cause the movable member to reciprocate between the first position and the second position.

Since the shaft portion is rotationally moved by being reciprocated about the central axis by the first driver, the movement by the shaft portion can be performed automatically with high precision.

Additionally, the first container portion may have a cylindrical portion formed in a cylindrical shape, the first member may be formed in a disk shape along an inner side surface of the cylindrical portion, the first flow path being formed by an arc-shaped notch, and a level-off portion may be formed on a circumferential end of the first member.

Since the level-off portion is formed on the circumferential end of the first member, it is possible to smoothly level off the particulate matter accommodated in the accommodation region formed in the movable member which is rotationally moved.

Additionally, an inclined surface inclined with respect to the vertical direction may be formed on the circumferential end of the first member.

Since an inclined surface is formed on the circumferential end of the first member, the resistance at the time of leveling off can be suppressed to a low level, and leveling off can be performed smoothly.

Additionally, the second member may support the first member and the movable member, the first member may be attached to the second member in a state where a gap is formed between the first member and the second member, and the movable member may move from the first position to the second position by moving in the gap.

Since the movable member is disposed in the gap between the first member and the second member and moves in the gap, the movable member can be easily replaced by taking out the movable member from the gap.

Additionally, two of the second flow paths may be formed in the second member.

Since two second flow paths are formed in the second member, if the movable member can reciprocate, particulate matter can be supplied to the second flow path each time the movable member reciprocates, and particulate matter can be supplied efficiently.

Additionally, two of the accommodation regions may be formed in the movable member.

Since two accommodation regions are formed in the movable member, if the movable member can reciprocate, particulate matter can be accommodated in the accommodation region and be leveled off each time the movable member reciprocates, and leveling off can be performed efficiently.

Additionally, when the movable member is disposed in a position where the accommodation region on one side of the two accommodation regions communicates with the second flow path on one side of the two second flow paths, the accommodation region on the other side may communicate with the first flow path, and when the movable member is disposed in a position where the accommodation region on the other side of the two accommodation regions communicates with the second flow path on the other side of the two second flow paths, the accommodation region on one side may communicate with the first flow path.

When one of the two accommodation regions is disposed in a position in communication with the second flow path, and the particulate matter after leveling off is supplied from the second flow path, the other accommodation region is disposed in a position in communication with the first flow path, and the particulate matter is supplied to the other accommodation region. Accordingly, if the movable member can reciprocate, supply of the particulate matter from the accommodation region through the second flow path and supply of the particulate matter to the accommodation region can be performed every time the movable member reciprocates. Hence, the supply of particulate matter and leveling off of particulate matter can be performed more efficiently.

Additionally, a second container portion may further be included, and the second container portion and the first member may be connected such that a space inside the second container portion communicates with the first flow path of the first member.

Since the second container portion is connected to the first member such that the internal space communicates with the first flow path, particulate matter can be supplied to the first path continuously by feeding the particulate matter into the internal space of the second container portion.

Additionally, the movable member may include a pin, a plate member capable of moving rotationally about the pin, and a plate portion attached to the plate member and having the accommodation region, and the plate member and the plate portion may be attached by engaging with each other.

Since the plate member and the plate portion are attached by engaging with each other, the plate portion can be easily removed by releasing the engagement with each other, and the plate portion can be easily replaced.

Additionally, a second driver that moves the plate member rotationally about the pin may further be included, and the second driver may move the plate member rotationally in forward and reverse directions to cause the movable member to reciprocate between the first position and the second position.

Since the second driver moves the plate member rotationally, the movement by the movable member can be performed automatically with high precision.

Additionally, a portion of the movable member in which the accommodation region is formed is changeable according to a desired amount of particulate matter falling from the second flow path.

Since the amount of particulate matter falling from the second flow path of particulate matter can be changed by changing the portion in which the accommodation region is formed in the movable member, the supply amount of particulate matter can be adjusted easily.

Additionally, a portion of the movable member in which the accommodation region is formed is changeable according to a desired falling position of particulate matter falling from the second flow path.

Since the falling position of particulate matter falling from the second flow path can be changed by changing the portion in which the accommodation region is formed in the movable member, the supply position of particulate matter can be changed easily.

Additionally, a supply portion that supplies particulate matter may be configured by an arm of a robot.

Since the supply portion is configured by an arm of a robot, particulate matter can be supplied with high precision.

### Advantageous Effects of Invention

According to the present invention, the configuration for driving a moving member can be reduced, and the configuration of the device can be simplified. Accordingly, the device can be downsized and the manufacturing cost of the device can be kept small.

### BRIEF DESCRIPTION OF DRAWINGS

FIG. 1 is a perspective view of a particulate matter supply device according to a first embodiment of the present invention.

FIG. 2 is a front view of a particulate matter supply device body portion of the particulate matter supply device of FIG. 1.

FIG. 3 is an enlarged perspective view of a supply portion of the particulate matter supply device of FIG. 1.

FIG. 4 is a plan view of the supply portion of FIG. 3 as viewed from below.

FIG. 5 is a perspective view showing a state in which a side portion and a bottom portion of a container portion of the supply portion of FIG. 3 are removed.

FIG. 6 is a block diagram showing the configuration of a control system of the particulate matter supply device of FIG. 1.

FIG. 7 is a perspective view showing a state in which a movable portion has moved in the supply portion of FIG. 3.

FIG. 8 is a plan view of the supply portion of FIG. 7 as viewed from below.

FIG. 9 is a perspective view showing a supply portion of a particulate matter supply device according to a second embodiment of the present invention.

FIG. 10 is a perspective view showing a state in which the supply portion of FIG. 9 is removed from an arm of a robot, and a container portion is removed.

FIG. 11 is a perspective view showing a state in which a movable portion has moved in the supply portion of FIG. 10.

FIG. 12 is perspective views each showing the supply portion when the movable portion moves to each of positions to which the movable portion is movable.

FIG. 13(a) is a perspective view showing a connection position of a connection plate to a plate portion, FIG. 13(b) is a perspective view showing a connection position of the plate portion to the connection plate, and FIG. 13(c) is a perspective view showing the connection position when the parts are connected.

FIG. 14 is perspective views each showing the shape of an accommodation region of a movable portion which has been replaced in order to change the supply of particulate matter.

FIG. 15 is an exploded perspective view showing a supply portion in order to describe the configuration of a form in which a movable portion moves linearly.

FIG. 16 is a perspective view of the supply portion of FIG. 15 when the movable portion is in a position close to a cylinder portion.

FIG. 17 is a perspective view showing the supply portion of FIG. 15 when the movable portion is in a position separated from the cylinder portion.

### DESCRIPTION OF EMBODIMENTS

Hereinafter, a particulate matter supply device according to an embodiment of the present invention will be described with reference to the accompanying drawings.

### First Embodiment

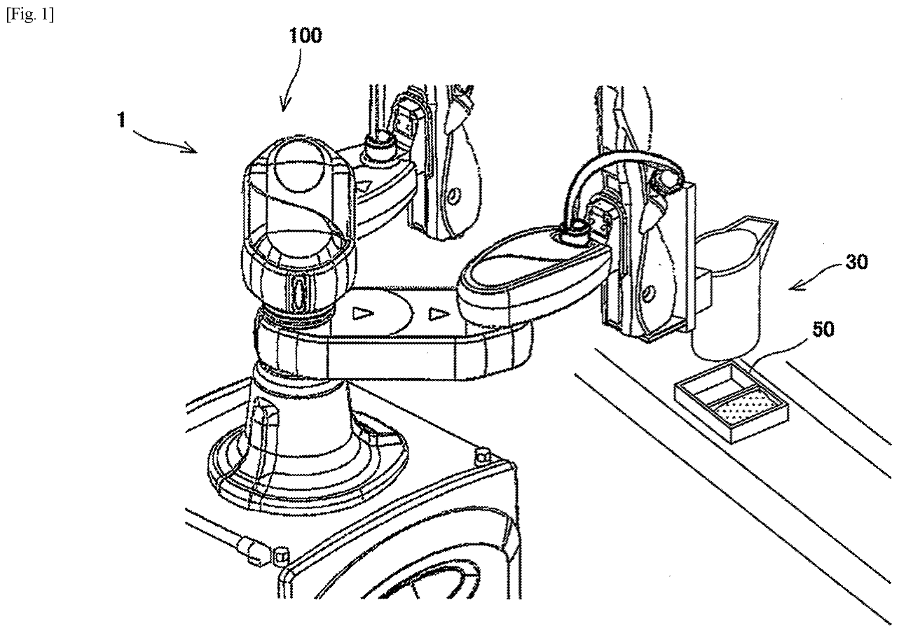

FIG. 1 shows a perspective view of a particulate matter supply device 1 according to a first embodiment of the present invention. The particulate matter supply device 1 includes a particulate matter supply device body portion 100 and a belt conveyor 60.

The belt conveyor 60 transports a box 50. The belt conveyor 60 is disposed so that the box 50 passes a position facing the particulate matter supply device body portion 100. An opening of the box 50 is opened upward.

Food is accommodated in the box 50. In the embodiment, cooked rice is accommodated in the box 50. Additionally, in the embodiment, sesame is used as the particulate matter. A fixed amount of sesame is sprinkled onto the cooked rice accommodated in the box 50 using the particulate matter supply device 1. However, the present invention is not limited to this. Other things may be used as the particulate matter. For example, food other than sesame, such as pepper and parsley processed into particulate matter, may be supplied to a supply target using the particulate matter supply device 1 of the present invention. Additionally, the particulate matter supply device 1 may be used for particulate matter other than food. Other particulate matter other than food may be used as long as the particulate matter is supplied in fixed amounts to the supply target.

Next, the configuration of the particulate matter supply device body portion 100 will be described.

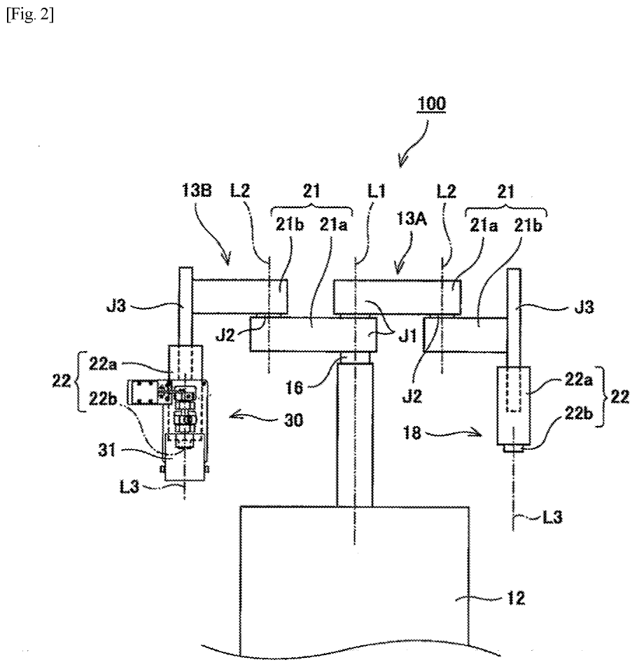

FIG. 2 shows a front view of the particulate matter supply device body portion 100 of the embodiment. As shown in FIG. 2, the particulate matter supply device body portion 100 is configured of a dual-arm selective compliance assembly robot arm (SCARA) robot including a pair of robot arms 13.

The particulate matter supply device body portion 100 includes a first robot arm 13A and a second robot arm 13B. A first holder 18 is provided on a tip end portion of the first robot arm 13A. A second holder 19 is provided on a tip end portion of the second robot arm 13B. Hereinafter, when the first robot arm 13A and the second robot arm 13B are not distinguished from each other, they are simply referred to as robot arm 13.

The particulate matter supply device body portion 100 includes a controller 14. Additionally, the particulate matter supply device body portion 100 may include a vacuum generator (not shown).

The controller 14 is provided inside a support 12 of the particulate matter supply device body portion 100, for example. However, the present invention is not limited to this, and the controller 14 may be provided inside the robot arm 13, for example. Additionally, the controller 14 may be provided in another vacant space.

Examples of the vacuum generator include a vacuum pump, a CONVUM (registered trademark), and the like. As in the case of the controller 14, the vacuum generator is provided inside the support 12, for example. However, the present invention is not limited to this, and the vacuum generator may be provided in another location such as the inside of the robot arm 13, for example. The vacuum generator may be connected to a later-described container portion 31 through an unillustrated pipe. For example, an unillustrated on-off valve is provided in the pipe, and the on-off valve opens and closes the pipe. The operation of the vacuum generator and the opening and closing of the on-off valve are controlled by the controller.

The first robot arm 13A moves the first holder 18 within a predetermined operation range. Additionally, the second robot arm 13B moves the second holder 19 within a predetermined operation range. The robot arm 13 is a SCARA, for example, and includes an arm portion 21 and a wrist portion 22. Additionally, the first robot arm 13A and the second robot arm 13B can operate independently of each other or operate in conjunction with each other.

Each of the first holder 18 and the second holder 19 is capable of holding a hand portion having a function. Note that in the embodiment, the first holder 18 does not hold a hand portion, and the second holder 19 holds a later-described supply portion 30 as the hand portion.

The particulate matter supply device body portion 100 includes a support 12 and a base shaft 16 extending vertically upward from the support 12. The base shaft 16 is rotatably attached to the support 12.

The arm portion 21 is attached to the base shaft 16 so as to extend in the horizontal direction. The arm portion 21 is attached so as to be rotatable about the base shaft 16.

The arm portion 21 includes a first link 21a and a second link 21b. The first link 21a and the second link 21b are supported so as to be rotatable relative to each other along the horizontal direction. The first robot arm 13A and the second robot arm 13B are connected to the base shaft 16 through the arm portion 21.

The arm portion 21 positions the wrist portion 22 attached to the tip end portion of each of the first robot arm 13A and the second robot arm 13B in an arbitrary position within the operation range.

The first link 21a is connected at its proximal end portion to the base shaft 16 of the support 12 by a rotary joint J1, and is rotatable about a rotation axis L1 passing through the shaft center of the base shaft 16. The second link 21b is connected to a tip end portion of the first link 21a by a rotary joint J2, and is rotatable about a rotation axis L2 defined at the tip end portion of the first link 21a.

The wrist portion 22 arbitrarily changes the posture of a mechanism connected to its end. The wrist portion 22 includes an elevation portion 22a and a rotation portion 22b. The elevation portion 22a is connected to a tip end portion of the second link 21b by a linear motion joint J3, and is capable of moving up and down with respect to the second link 21b. The rotation portion 22b is connected to a lower end portion of the elevation portion 22a by a rotary joint J4, and is capable of rotating about a rotation axis L3 defined at the lower end of the elevation portion 22a.

In the embodiment, the rotation axes L1 to L3 are parallel to one another, and extend in the vertical direction, for example. Additionally, the extending direction of the rotation axes L1 to L3 and the elevation direction of the elevation portion 22a are parallel to each other.

The arm 13 is provided with a servomotor (not shown) for driving, an encoder (not shown) for detecting the rotation angle of the servomotor, and the like, in association with each of the joints J1 to J4. Additionally, the rotation axis L1 of the first robot arm 13A and the rotation axis L1 of the second robot arm 13B are on the same straight line, and the first link 21a of the first robot arm 13A and the first link 21a of the second robot arm 13B are disposed with a height difference in the up-down direction.

Next, the hand portion held by the second holder 19 will be described. The second holder 19 holds, as a hand portion, the supply portion 30 that supplies the particulate matter to the inside of the box 50.

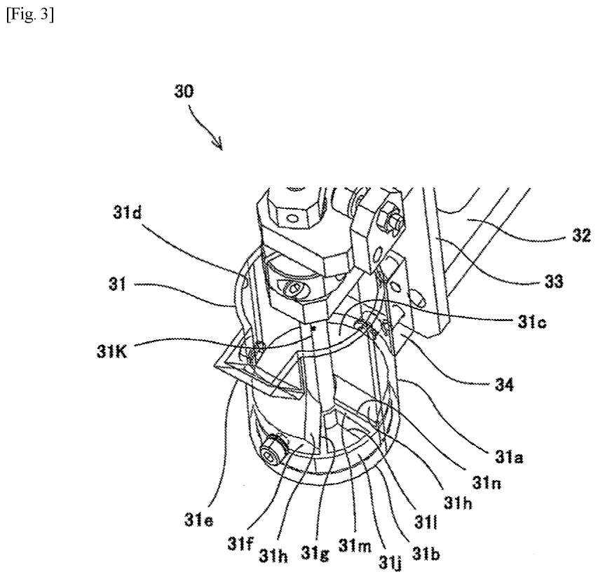

FIG. 3 shows an enlarged perspective view of the supply portion 30. In FIG. 3, a side portion 31a and a bottom portion 31b of the container portion 31 of the supply portion 30 are shown in a transparent manner for the sake of explanation.

The supply portion 30 will be described. The supply portion 30 is provided with the container portion (first container portion) 31. The container portion 31 is connected to the second holder 19 through a first connection member 32, a second connection member 33, and a third connection member 34. The first connection member 32 is held by the second holder 19. Additionally, the first connection member 32 is disposed so as to project frontward from an end portion of the second holder 19. The second connection member 33 is attached to the first connection member 32. The second connection member 33 is disposed so as to extend in the vertical direction. The third connection member 34 is attached to the second connection member. The third connection member 34 is disposed so as to extend in the vertical direction. The container portion 31 is attached to the third connection member 34. The container portion 31 is attached to the supply portion 30 by attaching the container portion 31 to the third connection member 34.

The container portion 31 has the side portion 31a and the bottom portion (second member) 31b. In the embodiment, the side portion 31a is formed in a cylindrical shape, and the bottom portion 31b is formed in a disk shape. Additionally, the container portion 31 has a space 31c defined by the side portion 31a and the bottom portion 31b. Particulate matter can be accommodated in the space 31c. Additionally, the space 31c is opened upward to form an opening 31d. The particulate matter can be supplied to the inside of the space 31c through the opening 31d to be accommodated in the space 31c. Additionally, the opening 31d of the container portion 31 has a feeding portion 31e where only a part along the circumferential direction protrudes outward in the radial direction in order to facilitate the supply of the particulate matter to the space 31c of the container portion 31.

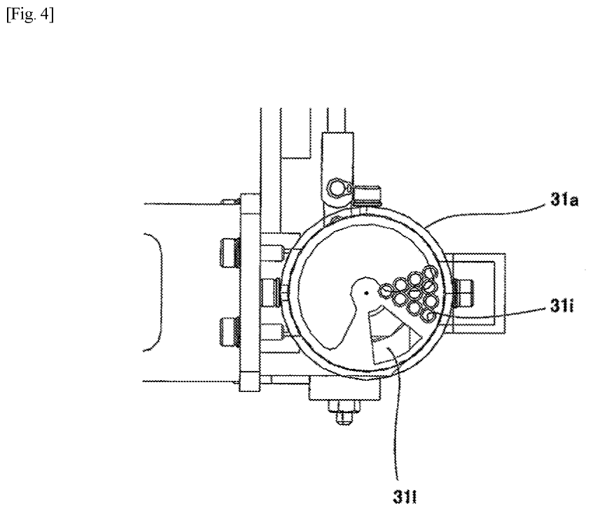

FIG. 4 shows a plan view of the supply portion 30 as viewed from below. In FIG. 4, the side portion a and the bottom portion 31b of the container portion 31 of the supply portion 30 are shown in a transparent manner for the sake of explanation. As shown in FIG. 4, the bottom portion 31b has a discharge port (second flow path) 31i penetrating the bottom portion 31b. The discharge port 31i is formed in a sufficient size allowing passage of particulate matter along the direction in which a movable portion 31j and the bottom portion 31b face each other. Additionally, the discharge port 31i is formed so as to penetrate the bottom portion 31b.

A fixing plate (first member) 31f fixedly attached to the side portion 31a of the container portion 31 to prevent movement of the side portion 31a is provided in the space 31c of the container portion 31. In the fixing plate 31f, a notch 31g cut in an arc shape is formed. An edge portion of the notch 31g is formed in a tapered shape, and the fixing plate 31f is configured such that the fixing plate 31f has an inclined surface 31h on a circumferential end thereof. Additionally, since the notch 31g is formed, a flow path (first flow path) 31m that allows passage of particulate matter penetrates the fixing plate 31f along the direction facing the movable portion 31j and the bottom portion 31b.

Additionally, since the notch 31g is formed in a part of the fixing plate 31f in the circumferential direction, the fixing plate 31f has a circumferential end 31n. In the fixing plate 31f, the circumferential end 31n is formed so as to extend along the vertical direction. Additionally, the fixing plate 31f has an inclined surface h inclined with respect to the end 31n and continuous with the end 31n. The end 31n and the inclined surface h in the fixing plate 31f function as a level-off portion for leveling off the particulate matter as will be described later. Note that while the level-off portion for leveling off is formed on both end portions in the circumferential direction of the fixing plate 31f in the embodiment, the present invention is not limited to this. In the fixing plate 31f, in a case where the portion to be leveled off is only one end, the fixing plate 31f may be configured such that the level-off portion is formed only on one end portion in the circumferential direction of the fixing plate 31f.

A discharge port 31i is disposed in a position offset from the notch 31g in the circumferential direction. The discharge port 31i may be formed in any position on the fixing plate 31f, as long as an offset of a sufficient distance for leveling off from the flow path 31m formed in the fixing plate 31f is secured. That is, the discharge port 31i only needs to have an offset of a sufficient distance for leveling off from the notch 31g.

Additionally, the movable portion (movable member) 31j is disposed between the fixing plate 31f and the bottom portion 31b in the space 31c of the container portion 31. In the embodiment, the movable portion 31j is formed in a disk shape. The movable portion 31j is disposed inside the container portion 31 in a region between the fixing plate 31f and the bottom portion 31b along the vertical direction, and is movable along the horizontal direction.

A shaft (shaft portion) 31k is disposed in the space 31c of the container portion 31 so as to extend in the vertical direction. The shaft 31k passes through the inside of the container portion 31, and is fixedly attached to the movable portion 31j. Accordingly, rotation of the shaft 31k about the central axis of the shaft 31k inside the space 31c of the container portion 31 enables rotational movement of the movable portion 31j. At this time, the shaft 31k rotates about the center of a circle of the horizontal cross section of the side portion 31a and a circle of the horizontal cross section of the bottom portion 31b, and this rotational movement causes rotational movement of the movable portion 31j.

In the movable portion 31j, an accommodation region 31l is formed so as to penetrate the movable portion 31j along a facing direction in which the fixing plate 31f and the bottom portion 31b face each other. The accommodation region 31l is formed so as to be able to accommodate particulate matter therein. The accommodation region 31l is formed in an arc shape corresponding to the shape of the notch 31g. The movable portion 31j is movable between a position (first position) at which the accommodation region 31l communicates with the flow path 31m formed in the fixing plate 31f, and a position (second position) at which the accommodation region 31l communicates with the discharge port 31i. Additionally, in the embodiment, the movable portion 31j is capable of reciprocating between these positions. Additionally, in the embodiment, the movable portion 31j is capable of moving between these positions by rotationally moving in the region between the fixing plate 31f and the bottom portion 31b. When the movable portion 31j moves rotationally between the fixing plate 31f and the bottom portion 31b, the movable portion 31j moves between the position where the accommodation region 31l communicates with the flow path 31m and the position where the accommodation region 31l communicates with the discharge port 31i.

In the state shown in FIG. 3 and FIG. 4, the movable portion 31j is disposed such that the accommodation region 31l is disposed in a position corresponding to the notch 31g. Since the accommodation region 31l is disposed in a position corresponding to the notch 31g and the discharge port 31i is disposed in a position offset from the notch 31g in the circumferential direction, the accommodation region 31l is disposed in a position offset from the discharge port 31i in the circumferential direction.

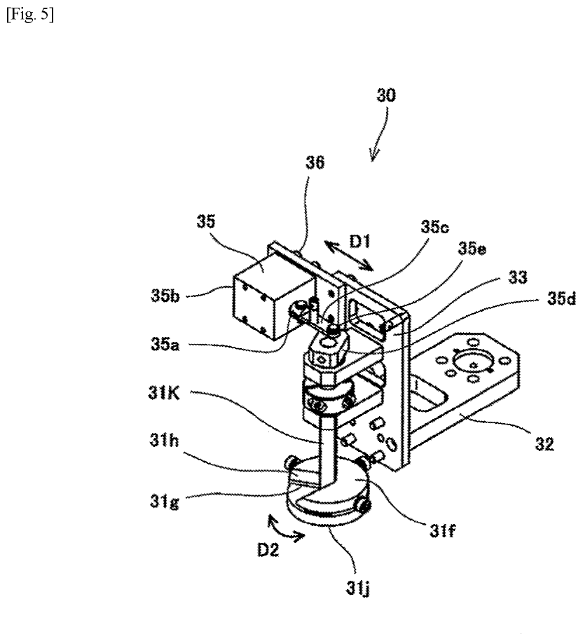

Next, FIG. 5 shows a perspective view of the supply portion 30 in a state in which the side portion 31a and the bottom portion 31b of the container portion 31 of the supply portion 30 are removed.

The supply portion 30 includes a driver (first driver) 35. The driver 35 is fixedly attached to the second connection member 33 through a fourth connection member 36.

The driver 35 is capable of moving an output portion 35a in a direction of approaching or separating from a driver body 35b. For example, in FIG. 4, the driver 35 is capable of moving the output portion 35a in a direction of approaching or separating from the driver body 35b along direction D1 shown in FIG. 4.

In the embodiment, the driver 35 is configured to have a solenoid, and by driving the solenoid, it is possible to move the output portion 35a in a direction of approaching or separating from the driver body 35b.

The output portion 35a of the driver 35 is connected to the shaft 31k through a first link 35c and a second link 35d. The first link 35c and the second link 35d are connected by a pin 35e. The driver 35 is capable of rotating and reciprocating the shaft 31k along direction D2 shown in FIG. 4, by moving the output portion 35a in a direction of approaching and separating from the driver body 35b. Thus, the drive of the driver 35 causes the shaft 31k to rotate about the central axis.

Rotation and reciprocation of the shaft 31k causes the movable portion 31j fixedly connected to the shaft 31k to rotate and reciprocate. As a result, the movable portion 31j can be rotationally moved and reciprocated along direction D2 shown in FIG. 5. When the driver 35 causes the shaft 31k to rotate about the central axis in forward and reverse directions, the movable portion 31j reciprocates between the position where the accommodation region 31l communicates with the flow path 31m and the position where the accommodation region 31l communicates with the discharge port 31i.

Additionally, since the shaft 31k is rotationally moved about the central axis by the driver 35, the movement by the shaft 31k can be performed automatically with high precision.

Additionally, in the embodiment, the shaft 31k is disposed so as to pass through the inside the container portion 31. Since the shaft 31k for rotationally moving the movable portion 31j is disposed so as to pass through the inside of the container portion 31, the configuration of the supply portion 30 can be downsized.

In the embodiment, when the shaft 31k rotates 45 degrees, the movable portion 31j moves from the position where the accommodation region 31l communicates with the flow path 31m to the position where the accommodation region 31l communicates with the discharge port 31i. Additionally, as the shaft 31k repeatedly moves rotationally in forward and reverse directions in the range of 45 degrees, the movable portion 31j reciprocates while rotating in the range of 45 degrees.

The supply portion 30 is held by the second holder 19, and is movable within a predetermined operation range by driving the second robot arm 13B.

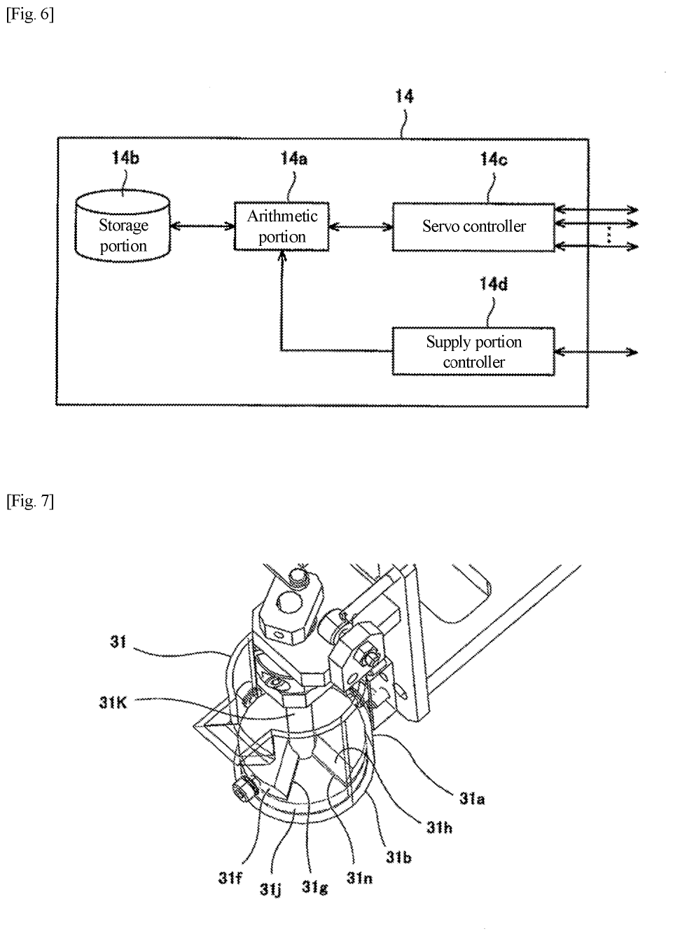

Next, the controller 14 that controls the operation of the particulate matter supply device body portion 100 will be described. FIG. 6 is a block diagram schematically showing a configuration example of a control system of the particulate matter supply device body portion 100.

As shown in FIG. 6, the controller 14 includes an arithmetic portion 14a, a storage portion 14b, a servo controller 14c, and a supply portion controller 14d.

The controller 14 is a robot controller provided with a computer such as a microcontroller, for example. Note that the controller 14 may be configured by a single controller 14 that performs centralized control, or may be configured by multiple controllers 14 that perform distributed control in cooperation with one another.

The storage portion 14b stores information such as a basic program as a robot controller and various fixed data. The arithmetic portion 14a controls various operations of the particulate matter supply device body portion 100 by reading and executing software such as the basic program stored in the storage portion 14b. That is, the arithmetic portion 14a generates a control command of the particulate matter supply device body portion 100, and outputs the control command to the servo controller 14c and the supply portion controller 14d.

The servo controller 14c is configured to control the drive of servo motors corresponding to each of the joints J1 to J4 of the first robot arm 13A and the second robot arm 13B of the particulate matter supply device body portion 100, on the basis of the control command generated by the arithmetic portion 14a.

The supply portion controller 14d controls the movement and operation of the supply portion 30 by controlling the driver on the basis of the control command generated by the arithmetic portion 14a.

A description will be given of an operation when particulate matter is supplied toward the opening of the box 50 by the particulate matter supply device 1 configured as described above.

When supplying particulate matter to the box 50, the particulate matter to be supplied to the box 50 is supplied toward the inside of the space 31c of the container portion 31. In the embodiment, the opening 31d of the container portion 31 has the feeding portion 31e where only a part along the circumferential direction protrudes outward in the radial direction. Hence, it is easy to supply particulate matter when supplying the particulate matter to the space 31c of the container portion 31.

At this time, the supply portion 30 of the particulate matter supply device body portion 100 is in the state shown in FIG. 3 and FIG. 4. In the state shown in FIG. 3 and FIG. 4, the accommodation region 31l of the movable portion 31j is disposed in a position corresponding to the notch 31g of the fixing plate 31f. Accordingly, in this state, the flow path 31m formed by the notch 31g communicates with the accommodation region 31l of the movable portion 31j. Hence, the space 31c of the container portion 31 communicates with the accommodation region 31l.

Since the space 31c communicates with the accommodation region 31l, when the particulate matter is fed into the space 31c, the particulate matter fed into the space 31c moves downward due to gravity and flows into the accommodation region 31l. Thus, the particulate matter is accommodated in the accommodation region 31l.

In this state, since the accommodation region 31l and the discharge port 31i are offset in the circumferential direction, a lower opening of the accommodation region 31l is covered with the bottom portion 31b. Accordingly, the particulate matter inside the accommodation region 31l is received and held by the bottom portion 31b and the wall surface defining the accommodation region 31l in the movable portion 31j.

When the particulate matter is supplied to the inside of the space 31c of the container portion 31 and supplied in excess of the capacity of the accommodation region 31l, the particulate matter overflows from the accommodation region 31l, and the particulate matter is filled up higher than the accommodation region 31l over the entire upper opening of the accommodation region 31l. When the particulate matter is thus filled up higher than the accommodation region 31l over the entire upper opening of the accommodation region 31l, the particulate matter accommodated in the accommodation region 31l can be leveled off.

Next, leveling off of the particulate matter supplied to the container portion 31 will be described.

When leveling off is performed, the movable portion 31j is moved while particulate matter is accommodated in the accommodation region 31l.

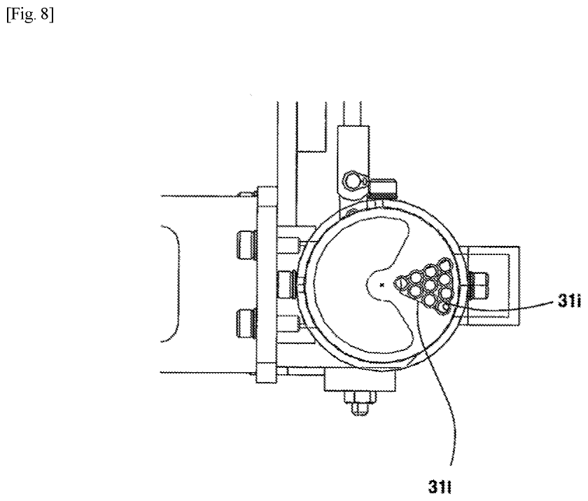

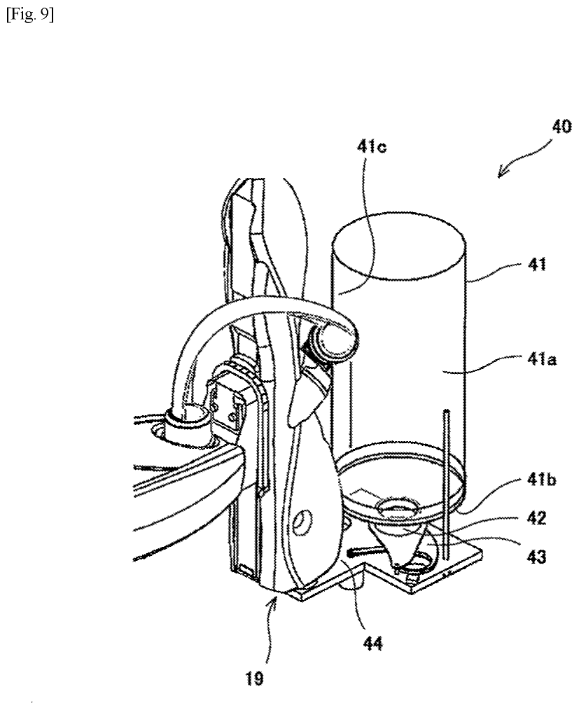

FIG. 7 shows a perspective view of the supply portion 30 in a state after the movable portion 31j has moved, and FIG. 8 shows a plan view of the supply portion 30 in the state of FIG. 7 as viewed from below. In the state shown in FIG. 7 and FIG. 8, the movable portion 31j rotates about the rotation axis of the shaft 31k from the state shown in FIG. 3 and FIG. 4 to move the accommodation region 31l to a region below the fixing plate 31f.

In the process of moving the movable portion 31j and moving the accommodation region 31l to the region below the fixing plate 31f, the particulate matter filled up to a position higher than the upper opening of the accommodation region 31l is leveled off by the circumferential end of the fixing plate 31f. Leveling off is performed by the circumferential end 31n of the fixing plate 31f.

When moving from the position where the accommodation region 31l communicates with the flow path 31m of the fixing plate 31f to the position where the accommodation region 31l communicates with the discharge port 31i, the movable portion 31j temporarily moves to the area below the fixing plate 31f. When the accommodation region 31l of the movable portion 31j moves to the area below the fixing plate 31f, a part of the particulate matter accommodated in the container portion 31 that is filled up to a position higher than the upper opening of the accommodation region 31l comes into contact with the circumferential end 31n and the inclined surface 31h of the fixing plate f. When the particulate matter filled up to a position higher than the upper opening of the accommodation region 31l comes into contact with the circumferential end 31n and the inclined surface 31h of the fixing plate f, the particulate matter in contact with the end 31n and the inclined surface 31h is pushed by the end 31n and the inclined surface 31h. Hence, the particulate matter filled up to a position higher than the upper opening of the accommodation region 31l cannot move along the circumferential direction.

Accordingly, while the particulate matter accommodated in the accommodation region 31l moves in the circumferential direction along with the movement of the movable portion 31j, the particulate matter filled up to a position higher than the upper opening of the accommodation region 31l comes into contact with the circumferential end 31n and the inclined surface 31h of the fixing plate f and cannot move in the circumferential direction. As a result, only the particulate matter accommodated in the accommodation region 31l moves in the circumferential direction along with the circumferential movement of the movable portion 31j. With this, only a fixed amount of particulate matter partitioned by the accommodation region 31l moves in the circumferential direction. As described above, when the movable portion 31j moves from the position where the accommodation region 31l communicates with the flow path 31m to the position where the accommodation region 31l communicates with the discharge port 31i, the amount of particulate matter exceeding the capacity of the accommodation region 31l is removed from the accommodation region 31l.

In the embodiment, since the level-off portion that performs leveling off is formed on the circumferential end of the fixing plate 31f, it is possible to smoothly level off the particulate matter accommodated in the accommodation region 31l formed in the movable portion 31j that is rotationally moved.

When the movable portion 31j moves, as shown in FIG. 7, the entire accommodation region 31l moves to the region below the fixing plate f. The movable portion 31j continues to move to a position where the accommodation region 31l of the movable portion 31j coincides with the discharge port 31i in the circumferential direction. After the movable portion 31j thus moves and moves the accommodation region 31l, the movable portion 31j is disposed such that the accommodation region 31l and the discharge port 31i are in circumferentially overlapping positions.

When the accommodation region 31l and the discharge port 31i are disposed in circumferentially overlapping positions, the particulate matter accommodated in the accommodation region 31l fall downward through the discharge port 31i due to gravity. As a result, a fixed amount of particulate matter accommodated in the accommodation region 31l is discharged through the discharge port 31i and supplied to the inside of the box 50 positioned below the supply portion 30. Thus, a fixed amount of particulate matter is supplied to the box 50.

Additionally, in the embodiment, the driver 35 is capable of continuously driving the shaft 31k to rotationally move and reciprocate the shaft 31k in a continuous manner. Accordingly, it is possible to rotationally move and reciprocate the movable portion 31j along direction D2 of FIG. 5 in a continuous manner. When the movable portion 31j reciprocates between the position where the accommodation region 31l communicates with the flow path 31m and the position where the accommodation region 31l communicates with the discharge port 31i, the particulate matter after leveling off can be discharged from the discharge port 31i continuously. For this reason, if particulate matter is sufficiently supplied to the inside of the space 31c of the container portion 31, fixed amounts of particulate matter can be supplied continuously by continuously driving the driver 35 to rotationally move and reciprocate the movable portion 31j along direction D2. In this way, it is possible to continuously supply a fixed amount of particulate matter by leveling off.

As described above, when the movable portion 31j moves in the circumferential direction in the region between the fixing plate 31f and the bottom portion b, the accommodation region 31l of the movable portion 31j moves circumferentially, and the particulate matter inside the accommodation region 31l is leveled off. At this time, when the accommodation region 31l moves from a position corresponding to the notch 31g to a position corresponding to the discharge port 31i, the particulate matter accommodated in the accommodation region 31l moves from the position corresponding to the notch 31g to the position corresponding to the discharge port 31i.

After the movable portion 31j moves to the region below the fixing plate 31f, the accommodation region 31l moves with the upper side closed and defined by a bottom surface of the fixing plate 31f and the lower side closed and defined by an upper surface of the bottom portion 31b. Accordingly, the particulate matter accommodated in the accommodation region 31l moves while being held in the accommodation region 31l in a securely enclosed state. The particulate matter is moved in a state of being securely held by the bottom surface of the fixing plate 31f, the upper surface of the bottom portion 31b, and an inner side surface of the accommodation region 31l in the movable portion 31j.

At this time, the movable portion 31j moves the particulate matter while holding the particulate matter using not only the inner side surface of the accommodation region 31l in the movable portion 31j, but also the bottom surface of the fixing plate 31f and the upper surface of the bottom portion 31b. Accordingly, it is only necessary to move the movable portion 31j in order to move the particulate matter. That is, to level off and move the particulate matter, both movements including the relative movement between the end 31n of the fixing plate 31f and the accommodation region 31l of the particulate matter and the movement of the particulate matter to the discharge port 31i after leveling off can be performed by a single movement of the movable portion 31j. Only by moving the movable portion 31j, both of the movement of the particulate matter for leveling off the particulate matter and the movement of the particulate matter to the discharge port 31i can be performed. Accordingly, the number of members to be moved can be reduced, and the configuration of the supply portion 30 can be simplified. Additionally, since the number of members to be moved is reduced, the number of drivers for moving the members can be reduced. Accordingly, the configuration of the supply portion 30 can be further simplified. Hence, the configuration of the particulate matter supply device 1 can be simplified.

The simple configuration of the supply portion 30 can downsize the supply portion 30. Accordingly, as in the embodiment, the supply portion 30 can be easily configured by an arm of a robot.

Additionally, since the configuration of the supply portion 30 is simplified, the manufacturing cost of the supply portion 30 can be reduced. Additionally, since the number of drivers to be driven to move the members is reduced, the control of the drivers is simplified, and the control by the controller 14 is simplified. Accordingly, a high-performance controller 14 is not necessary, and the manufacturing cost of the particulate matter supply device 1 can be further reduced.

Additionally, in the embodiment, the bottom portion 31b forms a part of the container portion 31, and the discharge port 31i is formed in the bottom portion 31b. Additionally, the fixing plate 31f and the movable portion 31j are accommodated inside the container portion 31. Accordingly, the space 31c for accommodating the particulate matter, the fixing plate 31f for leveling off, the movable portion 31j for moving the particulate matter by moving the accommodation region 31l, and the discharge port 31i are included in the container portion 31. Hence, the supply portion 30 is formed so as to compactly include the configuration of the supply portion 30, and the supply portion 30 can be downsized.

Additionally, in the embodiment, since the movable portion 31j moves by rotational movement, the range in which the movable portion 31j moves can be made smaller than a range when the movable portion 31j moves by linear movement. Accordingly, the configuration of the supply portion 30 can be downsized, and the configuration of the device can be downsized.

Additionally, in the embodiment, the fixing plate 31f is fixedly attached to the inside of the container portion 31, the bottom portion 31b forms a bottom portion of the container portion 31, and the movable portion 31j is disposed inside the container portion 31 between the fixing plate 31f and the bottom portion 31b. Thus, the fixing plate 31f, the bottom portion 31b, and the movable portion 31j are stored in the container portion. Accordingly, the supply portion 30 can be downsized, and the configuration of the particulate matter supply device 1 can be downsized.

Additionally, in the embodiment, the circumferential end 31n that partitions the notch 31g in the fixing plate 31f is formed along the vertical direction, and is continuous with the inclined surface 31h inclined with respect to the end 31n. The inclined surface 31h is formed on both end portions in the circumferential direction of the fixing plate 31f. Since the inclined surface 31h is formed on the circumferential end of the fixing plate 31f, when leveling off particulate matter accommodated in the accommodation region 31l of the movable portion 31j by the fixing plate 31f, the particulate is allowed to flow along the inclined surface 31h. Accordingly, the resistance from the particulate matter when leveling off with the fixing plate 31f can be suppressed, and the leveling off can be performed smoothly. For this reason, there is no need for a large force to move the movable portion 31j, and the driving force of the driver 35 need not be increased. Hence, the manufacturing cost of the particulate matter supply device 1 can be kept small.

Additionally, in the embodiment, the driver 35 reciprocates the output portion 35a along direction D1 by a solenoid in a direction of approaching and separating from the driver body 35b. Accordingly, the output portion 35a can reciprocate at high speed along direction D1. As a result, it is possible to supply fixed amounts of particulate matter to the box 50 at high speed. Additionally, since the output portion 35a is reciprocated along direction D1 by the solenoid, the reciprocation can be performed with a simple configuration, and the manufacturing cost of the particulate matter supply device 1 can be kept small.

Additionally, in the embodiment, since the supply portion 30 is downsized, the supply portion 30 is sized appropriately to be configured by an arm of a robot. Thus, by downsizing, the supply portion 30 can be configured as an arm of a robot.

Additionally, since the supply portion 30 is configured by an arm of a robot, positioning by the supply portion 30 can be performed correctly. Accordingly, particulate matter can be easily supplied to the inside of the box 50 being conveyed along the belt conveyor 60. Additionally, since the supply portion 30 of the particulate matter supply device 1 is configured by an arm of a robot, supply of particulate matter can be performed with high precision.

Note that in the embodiment, the first holder 18 of the particulate matter supply device body portion 100 does not hold a hand portion as an end effector, and is not involved in the supply of particulate matter. However, the present invention is not limited to this, and the first holder 18 may hold an end effector. For example, the first holder 18 may hold a guide portion that guides transport of the box 50 transported along the belt conveyor 60, such that the transported box 50 is moved and disposed to a position directly below the supply portion 30. Additionally, end effectors having other configurations may be held.

### Second Embodiment

Next, a particulate matter supply device according to a second embodiment of the present invention will be described. Note that descriptions will be omitted on parts configured similarly to the above first embodiment, and descriptions will be given only on different parts.

In the second embodiment, a second holder 19 includes a supply portion 40. FIG. 9 shows a perspective view of the periphery of the supply portion 40 of the particulate matter supply device according to the second embodiment.

The supply portion 40 of the second embodiment includes a container portion (second container portion) 41, a level-off portion (first member) 42 for leveling off, a movable portion (movable member) 43 that moves with particulate matter accommodated inside an accommodation region to move the particulate matter to a discharge port while leveling off, and a connection portion (second member) 44 for connecting the second holder 19 and the movable portion 43. In FIG. 9, the container portion 41 is shown in a transparent manner for the sake of explanation.

The second holder 19 holds the connection portion 44. The connection portion 44 is attached to the second holder 19 so as to project frontward from the second holder 19.

The container portion 41, the level-off portion 42, and the movable portion 43 are disposed on the connection portion 44. The container portion 41, the level-off portion 42, and the movable portion 43 are attached on the connection portion 44 such that the connection portion 44 supports the container portion 41, the level-off portion 42, and the movable portion 43.

The container portion 41 has a space 41c, and is capable of supplying particulate matter to the inside of the space 41c. The container portion 41 has a cylindrical portion 41a formed in a cylindrical shape and a conical portion 41b formed in a conical shape in a position close to the level-off portion 42. The conical portion 41b is connected to the level-off portion 42 at a lower end portion.

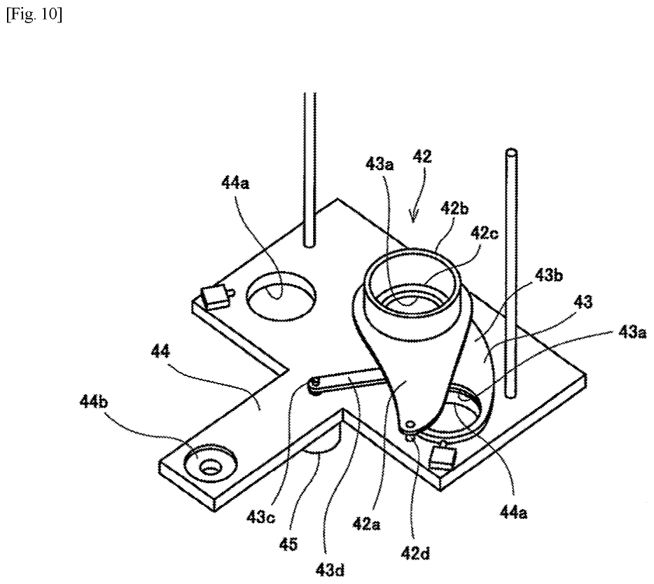

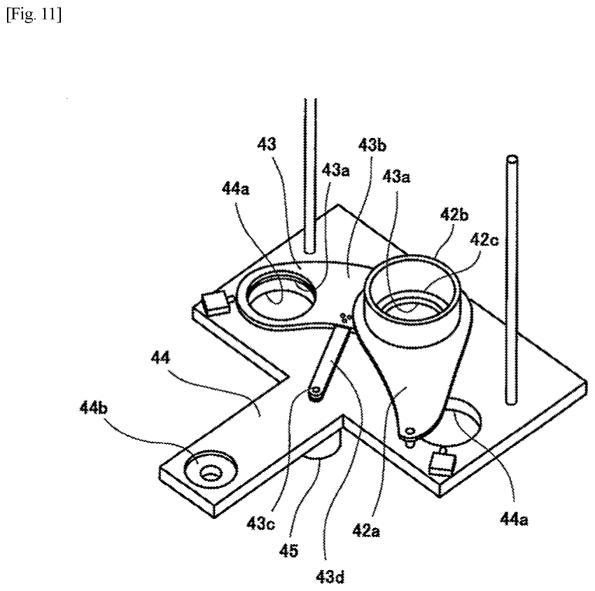

FIG. 10 shows a perspective view of the level-off portion 42 and the movable portion 43 disposed on the connection portion 44.

The level-off portion 42 has a flat plate portion 42a and a cylindrical portion 42b. The plate portion 42a is fixedly attached to the connection portion 44. This fixedly attaches the level-off portion 42 to the connection portion 44.

The cylindrical portion 42b is connected to the plate portion 42a. A through hole 42c is formed in the plate portion 42a so as to penetrate the plate portion 42a in the thickness direction. The cylindrical portion 42b and the plate portion 42a are connected in a position surrounding the through hole 42c. Additionally, the cylindrical portion 42b and the plate portion 42a are connected so that an inner wall surface of the cylindrical portion 42b is continuous with a side surface of the plate portion 42a surrounding the through hole 42c. The inner wall surface of the cylindrical portion 42b and the through hole 42c in the plate portion 42a are formed so as to penetrate the level-off portion 42, and function as a flow path (first flow path) that allows passage of particulate matter. The particulate matter is supplied from the container portion 41 through the level-off portion 42 to an accommodation region 43a of the movable portion 43 through the flow path. The container portion 41 and the level-off portion 42 are connected such that the space inside the container portion 41 communicates with an inner wall surface of the cylindrical portion 42b of the level-off portion 42 and the through hole 42c in the plate portion 42a. Since the container portion 41 is connected to the level-off portion 42 so that the internal space communicates with the flow path that allows the particulate matter to pass through to the accommodation region 43a, the particulate matter can be continuously supplied to the flow path by feeding the particulate matter into the internal space of the container portion 41.

A gap is formed between the level-off portion 42 and the connection portion 44, and the movable portion 43, the connection portion 44, and the level-off portion 42 are configured so that the movable portion 43 can be positioned in the gap. Hence, the level-off portion 42 is attached in a position where there is a gap between the level-off portion 42 and the connection portion 44. In the embodiment, the level-off portion 42 is attached to the connection portion 44 in a state in which a columnar member 42d is sandwiched between the level-off portion 42 and the connection portion 44.

The movable portion 43 is disposed between the level-off portion 42 and the connection portion 44. The movable portion 43 has the accommodation region 43a that penetrates the movable portion 43 in a facing direction in which the level-off portion and the connection portion 44 face each other and can accommodate the particulate matter therein. In the embodiment, two accommodation regions 43a are formed in the movable portion 43. Additionally, the movable portion 43 is movable along the horizontal direction on the surface of the connection portion 44 between the level-off portion 42 and the connection portion 44. Since the movable portion 43 is disposed in the gap between the level-off portion 42 and the connection portion 44 and moves in the gap, the movable portion 43 can be easily replaced by taking out the movable portion 43 from the gap.

The movable portion 43 is movable to a position (first position) at which the accommodation region 43a communicates with the through hole 42c in the level-off portion 42, and to a position (second position) at which the accommodation region 43a communicates with a discharge port 44a. Additionally, the movable portion 43 is capable of reciprocating between the position where the accommodation region 43a communicates with the through hole 42c in the level-off portion 42 and the position where the accommodation region 43a communicates with the discharge port 44a.

Additionally, the movable portion 43 has a plate portion 43b that is formed in a flat plate shape and defines the side surface of the accommodation region 43a, a pin 43c, and a connection plate (plate member) 43d that can move rotationally about the pin 43c. The plate portion 43b is attached to the connection plate 43d, and the accommodation region 43a is formed in the plate portion 43b. The connection plate 43d is capable of moving rotationally about the pin 43c. Additionally, the movable portion 43 is capable of reciprocating between the position where the accommodation region 43a communicates with the through hole 42c in the level-off portion 42 and the position where the accommodation region 43a communicates with the discharge port 44a, by moving rotationally in the gap between the level-off portion 42 and the connection portion 44. Additionally, the movable portion 43 is capable of reciprocating between the position where the accommodation region 43a communicates with the through hole 42c in the level-off portion 42 and the position where the accommodation region 43a communicates with the discharge port 44a, by moving in the gap between the level-off portion 42 and the connection portion 44.

When the connection plate 43d moves rotationally about the pin 43c along the surface of the connection portion 44, the plate portion 43b moves rotationally about the pin 43c along the surface of the connection portion 44. Accordingly, the accommodation region 43a formed in the plate portion 43b moves rotationally about the pin 43c along the surface of the connection portion 44.

The discharge port (second flow path) 44a as a through hole is formed in the connection portion 44 so as to penetrate the connection portion 44. The discharge port 44a is formed so as to allow passage of particulate matter. In the embodiment, two discharge ports 44a are formed in the connection portion 44. Additionally, the connection portion 44 has a held portion 44b held by the second holder 19 of the particulate matter supply device body portion 100.

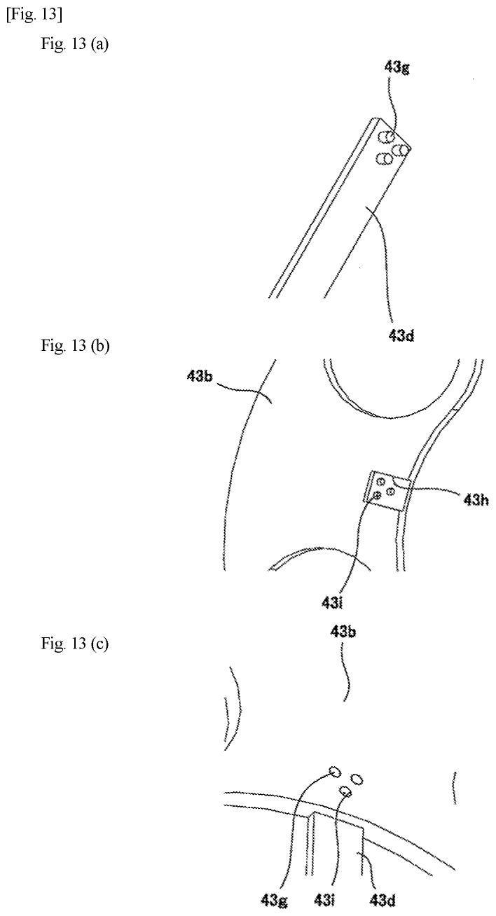

In the embodiment, two accommodation regions 43a are formed in the movable portion 43, and two discharge ports 44a are formed in the connection portion 44. The movable portion 43 is configured such that when an accommodation region 43e on one side of the two accommodation regions 43a is disposed in a position in communication with a discharge port 44c on one side of the two discharge ports 44a, an accommodation region 43f on the other side can be disposed in a position in communication with the inside of the cylindrical portion 42b of the level-off portion 42 and the through hole 42c (FIG. 12(b)). Additionally, when the accommodation region 43f on the other side of the two accommodation regions 43a is disposed in a position in communication with a discharge port 44d on the other side of the two discharge ports 44a, the accommodation region 43e on one side can be disposed in a position in communication with the inside of the cylindrical portion 42b of the level-off portion 42 and the through hole 42c (FIG. 12(a)).

A driver (second driver) 45 is disposed on the back side of the connection portion 44 opposite to the side on which the level-off portion 42, the movable portion 43, and the container portion 41 are attached. The driver 45 drives the connection plate 43d to move the connection plate 43d rotationally through the pin 43c. By driving the driver 45, it is possible to rotationally move the connection plate 43d about the pin 43c along the horizontal direction on the connection portion 44. In the embodiment, the driver 45 is capable of rotationally moving the connection plate 43d along the horizontal direction on the connection portion 44 within an angle range of approximately 90 degrees. By driving the driver 45, the connection plate 43d is rotationally moved through the pin 43c, and accordingly, it is possible to rotationally move the accommodation region 43a formed in the plate portion 43b and the plate portion 43b about the pin 43c. Additionally, the driver 45 is capable of moving the connection plate 43d rotationally in forward and reverse directions to reciprocate the movable portion 43 between the position where the accommodation region 43a communicates with the through hole 42c in the level-off portion 42 and the position where the accommodation region 43a communicates with the discharge port 44a. Since the driver 45 moves the connection plate 43d rotationally, the movement by the movable portion 43 can be performed automatically with high precision.

When the particulate matter is supplied to the inside of the box 50 by the supply portion 40 configured as described above, the particulate matter is first supplied to the inside of the container portion 41. When the particulate matter is supplied to the inside of the container portion 41, the particulate matter falls due to gravity, and the particulate matter is supplied to the inside of the accommodation region 43a formed in the plate portion 43b of the movable portion 43 through the cylindrical portion 42b of the level-off portion 42 and the through hole 42c in the plate portion 42a.

When the particulate matter is supplied, the particulate matter overflows from the accommodation region 43a over the entire upper opening of the accommodation region 43a, and the particulate matter is filled up to a position higher than the upper opening of the accommodation region 43a. In this state, it is possible to level off the particulate matter in the accommodation region 43a.

When leveling off the particulate matter inside the accommodation region 43a, the movable portion 43 is moved until the accommodation region 43a in the position in communication with the through hole 42c of the level-off portion 42 reaches a position in communication with the discharge port 44a formed in the connection portion 44.

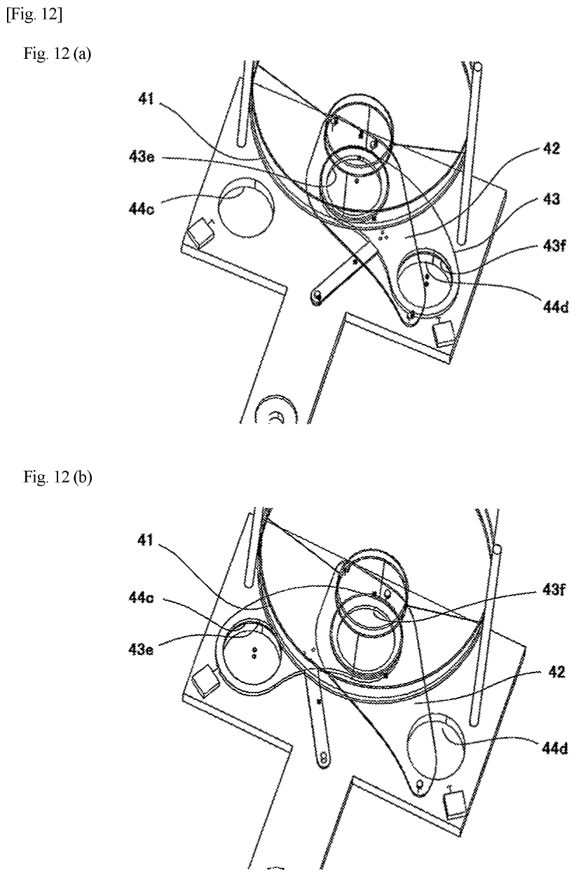

FIG. 11 shows a perspective view of the level-off portion 42 and the movable portion 43 disposed on the connection portion 44, when the movable portion 43 is moved until the accommodation region 43a in the position in communication with the through hole 42c of the level-off portion 42 reaches the position in communication with the discharge port 44a formed in the connection portion 44.

When the movable portion 43 moves in a state in which the particulate matter is accommodated in the accommodation region 43a, the accommodation region 43a is disengaged from the position in communication with the flow path inside the cylindrical portion 42b of the level-off portion 42, and the accommodation region 43a is temporarily disposed in a position below the level-off portion 42. When the accommodation region 43a moves from the position in communication with the flow path inside the cylindrical portion 42b to the position below the level-off portion 42, the particulate matter inside the accommodation region 43a is leveled off. When the accommodation region 43a moves from the position connected to the flow path inside the cylindrical portion 42b to the position below the level-off portion 42, the particulate matter overflowed from the upper opening of the accommodation region 43a and filled up to a position higher than the upper opening of the accommodation region 43a is leveled off by the inner wall surface of the cylindrical portion 42b. Thus, the particulate matter accommodated in the accommodation region 43a is leveled off, and a fixed amount of particulate matter determined by the shape of the accommodation region 43a is accommodated in the accommodation region 43a.

The movable portion 43 moves from the state in which the accommodation region 43a is positioned below the level-off portion 42 to a position where the accommodation region 43a is connected to the discharge port 44a formed in the connection portion 44 as shown in FIG. 11. When the accommodation region 43a is connected to the discharge port 44a, the particulate matter accommodated inside the accommodation region 43a falls through the discharge port 44a due to gravity. As a result, the particulate matter is supplied to the inside of the box 50 disposed in a position directly below the supply portion 40. At this time, the particulate matter falling through the discharge port 44a is a fixed amount of particulate matter that has been leveled off by the level-off portion 42. Thus, the fixed amount of particulate matter that has been leveled off by the level-off portion 42 is supplied to the box 50.

Additionally, the driver 45 can move the movable portion 43 rotationally by continuously reciprocating the movable portion 43 about the pin 43c. Hence, if a sufficient amount of particulate matter is supplied to the inside of the container portion 41, the driver 45 causes the movable portion 43 to move rotationally by continuously reciprocating the movable portion 43 about the pin 43c, so that a fixed amount of particulate matter can be discharged from the discharge port 44a and be supplied to the box 50.

The movement of particulate matter when supplied from the container portion 41 to the two accommodation regions 43a will be described with reference to FIGS. 12(a) and 12(b).

FIGS. 12(a) and 12(b) each show a perspective view of the container portion 41, the level-off portion 42, the movable portion 43, and the connection portion 44 when the movable portion 43 is in one of the two positions that the movable portion 43 reciprocates between. FIG. 12(a) shows a state in which the accommodation region 43e on one side of the two accommodation regions 43a formed in the movable portion 43 communicates with the flow path inside the cylindrical portion 42b of the level-off portion 42 and the container portion 41. Additionally, FIG. 12(b) shows a state in which the accommodation region 43f on the other side opposite to the one side of the two accommodation regions 43a formed in the movable portion 43 communicates with the flow path inside the cylindrical portion 42b of the level-off portion 42 and the container portion 41.

In the position shown in FIG. 12(a), the accommodation region 43e on one side communicates with the flow path inside the cylindrical portion 42b of the level-off portion 42 and the container portion 41, so that the particulate matter accommodated inside the container portion 41 is supplied to the inside of the accommodation region 43e on one side. When the particulate matter is supplied to the accommodation region 43e, the movable portion 43 passes the position below the level-off portion 42 and moves to become the state shown in FIG. 12(b). When the movable portion 43 passes the position below the level-off portion 42, the particulate matter accommodated in the accommodation region 43a is leveled off by the level-off portion 42, and the particulate matter overflowed from the accommodation region 43e and filled up to a position higher than the upper opening of the accommodation region 43e is leveled off.

Thereafter, in the state shown in FIG. 12(b), the accommodation region 43e on one side accommodating a fixed amount of particulate matter after being leveled off is disposed in a position in communication with the discharge port 44c on one side of the two discharge ports 44a. As a result, a fixed amount of particulate matter is discharged from the discharge port 44c on one side.

At this time, as shown in FIG. 12(b), the accommodation region 43f on the other side is disposed in a position in communication with the flow path inside the cylindrical portion 42b of the level-off portion 42 and the container portion 41. Hence, the particulate matter accommodated in the container portion 41 is supplied to the inside of the accommodation region 43f on the other side. Thus, in the state shown in FIG. 12(b), the particulate matter accommodated in the accommodation region 43e on one side is discharged from the discharge port 44c, while the particulate matter accommodated in the container portion 41 is supplied to the accommodation region 43f on the other side.

While the particulate matter accommodated in the accommodation region 43e on one side is discharged from the discharge port 44c, the particulate matter is supplied toward the accommodation region 43f on the other side. At this time, the particulate matter is supplied downward due to gravity, and the particulate matter is supplied from the container portion 41 through the flow path inside the cylindrical portion 42b of the level-off portion 42 and the through hole 42c formed in the plate portion 42a, and falls into the accommodation region 43f on the other side.

In the state shown in FIG. 12(b), when the particulate matter accommodated in the accommodation region 43e on one side is discharged from the discharge port 44c and the particulate matter is accommodated in the accommodation region 43f on the other side, the movable portion 43 is moved. At this time, the movable portion 43 moves to become the state shown in FIG. 12(a) in which the accommodation region 43e on one side communicates with the flow path inside the cylindrical portion 42b of the level-off portion 42 and the container portion 41, and the accommodation region 43f on the other side communicates with the discharge port 44d on the other side. When the movable portion 43 moves to become the state shown in FIG. 12(a), the accommodation region 43f on the other side temporarily passes the position below the level-off portion 42. At this time, the particulate matter accommodated in the accommodation region 43f on the other side is leveled off.

When the movable portion 43 moves to become the state shown in FIG. 12(a), the accommodation region 43f on the other side communicates with the discharge port 44d on the other side. Accordingly, the particulate matter accommodated in the accommodation region 43f on the other side after leveling off is discharged from the discharge port 44d on the other side. Additionally, at this time, since the accommodation region 43e on one side communicates with the flow path inside the cylindrical portion 42b of the level-off portion 42 and the container portion 41, the particulate matter can be supplied to the accommodation region 43e on one side.

Thus, by alternately repeating the state shown in FIG. 12(a) and the state shown in FIG. 12(b), fixed amounts of particulate matter can be supplied from each of the discharge ports 44a.

In the embodiment, the movable portion 43 is not disposed inside the container portion 41 but exposed to the outside. Accordingly, the movable portion 43 is configured to be easily accessible. Hence, as compared with a configuration in which the movable portion 43 is disposed inside the container portion 41, the plate portion 43b of the movable portion 43 can be replaced easily.

Additionally, since the movable portion 43 is easily accessible, the periphery of the movable portion 43 can be cleaned easily. As a result, the periphery of the movable portion 43 can be kept clean.

Next, a connection portion between the plate portion 43b and the connection plate 43d of the movable portion 43 will be described. FIG. 13(a) shows an enlarged perspective view of a position of the connection plate 43d to be connected to the plate portion 43b.

A protrusion 43g protruding in the thickness direction from the connection plate 43d is formed in a peripheral position at an end portion of the connection plate 43d to be connected to the plate portion 43b. In the embodiment, three protrusions 43g protruding in the thickness direction are formed at peripheral positions at the end portion of the connection plate 43d.

FIG. 13(b) shows an enlarged perspective view of the periphery of a position of the plate portion 43b to be connected with the connection plate 43d. A recess 43h is formed in the position of the plate portion 43b to be connected to the connection plate 43d, and a hole 43i penetrating the connection plate 43d in the thickness direction is formed in the recess 43h. In the embodiment, three holes 43i are formed in the recess 43h at positions corresponding to the protrusions 43g of the connection plate 43d.

The end portion of the connection plate 43d to be connected to the plate portion 43b is inserted into the recess 43h, and the protrusions 43g formed on the connection plate 43d are inserted and fitted into the holes 43i to connect he connection plate 43d and the plate portion 43b.

FIG. 13(c) is an enlarged perspective view of a connection portion where the connection plate 43d and the plate portion 43b are connected. In the embodiment, the connection plate 43d and the plate portion 43b are attached by engaging with each other. Since the connection plate 43d and the plate portion 43b are attached by engaging with each other, the plate portion 43b can be easily removed by releasing the engagement with each other, and the plate portion 43b can be attached easily to the connection plate 43d. Accordingly, the plate portion 43b can be replaced easily.

Thus, since the plate portion 43b can be easily removed from the connection plate 43d and the plate portion 43b can be easily attached to the connection plate 43d, the plate portion 43b can be replaced easily.

In the embodiment, when fixed amounts of particulate matter is supplied toward the inside of the box 50, the supply amount of particulate matter is determined by the shape of the accommodation region 43a formed in the plate portion 43b of the movable portion 43. Accordingly, by selecting the movable portion 43 having the accommodation region 43a of an appropriate supply amount according to the desired supply amount, particulate matter of the desired supply amount can be supplied. In the embodiment, since the plate portion 43b of the movable portion 43 can be replaced easily, replacement to the plate portion 43b having the accommodation region 43a according to the desired supply amount can be facilitated. As described above, it is possible to change the plate portion 43b of the movable portion 43 according to the desired amount of particulate matter falling from the discharge port 44a. That is, it is possible to change the portion in which the accommodation region 43a is formed according to the desired supply amount of particulate matter. Since the supply amount of particulate matter can be changed by changing the plate portion 43b of the movable portion 43, the supply amount of particulate matter can be adjusted easily.

Additionally, by changing the accommodation region, it is possible to adjust the supply position of particulate matter when the particulate matter is supplied to the inside of the box 50. It is possible to change the plate portion 43b of the movable portion 43 according to the desired falling position of particulate matter falling from the discharge port 44a. That is, it is possible to change the portion in which the accommodation region 43a is formed according to the desired falling position of particulate matter falling from the discharge port 44a. Since the falling position of particulate matter falling from the discharge port 44a can be changed by changing the plate portion 43b of the movable portion 43, the supply position of particulate matter can be changed easily.

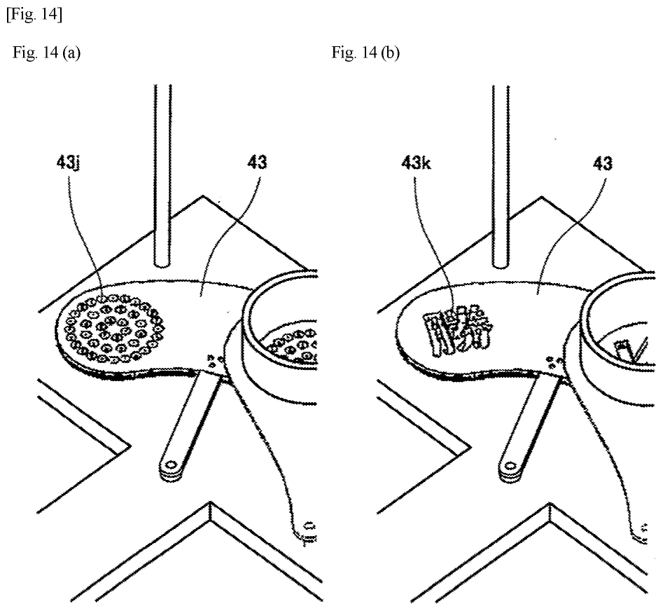

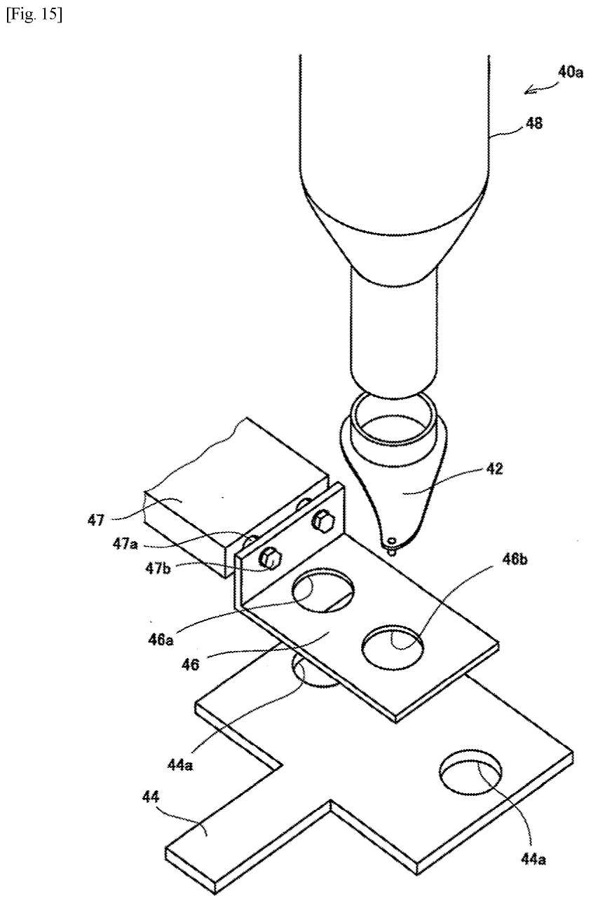

FIGS. 14(a) and 14(b) are perspective views showing the accommodation region when the shape of the accommodation region is changed in order to adjust the supply position of particulate matter. FIG. 14(a) shows a perspective view of the movable portion 43 in which an accommodation region 43j is formed concentrically, so that the particulate matter is supplied to the inside of the box 50 along the shape of the concentric circles.

As shown in FIG. 14(a), since the accommodation region 43j is formed concentrically, the particulate matter discharged from the discharge port 44a and supplied to the inside of the box 50 is supplied so as to draw concentric circles inside the box 50. Thus, a pattern of a desired shape can be formed by particulate matter inside the box 50, and an enjoyable appearance can be presented inside the box 50.

Additionally, as shown in FIG. 14(b), the accommodation region can be formed in a character shape, and the particulate matter supplied to the inside of the box 50 can be supplied along the shape of the character. FIG. 14(b) shows a perspective view of an accommodation region 43k when the accommodation region 43k is formed along the shape of “katsu”, for example, as an example of the character.

Thus, since particulate matter can be supplied to the inside of the box 50 along the shape of a character, an enjoyable appearance can be presented inside the box 50. Additionally, it becomes possible to leave a message inside the box 50 with particulate matter. As a result, a message can be transmitted to a person who picks up the box 50 after the box 50 has been distributed to the market, for example.

Note that while the particulate matter supply device according to the second embodiment has been described as a form using a plate portion of the movable portion having an accommodation region suitable for the desired supply amount or supply position of particulate matter, the present invention is not limited to this. A plate portion of the movable portion having an accommodation region suitable for the desired supply amount or supply position of particulate matter may be selected and used in the particulate matter supply device of the first embodiment as well. Additionally, a plate portion of the movable portion having an accommodation region suitable for the desired supply amount or supply position of particulate matter may be selected and used in particulate matter supply devices of other embodiments as well.

Additionally, in the embodiment, since the plate portion 43b of the movable portion 43 can be replaced easily, a desired plate portion 43b can be attached according not only to the supply amount but also to the supply position of particulate matter such as a pattern or character. Accordingly, the plate portion 43b of the movable portion 43 can be attached easily according to the desired supply amount or shape, and a user-friendly particulate matter supply device can be provided.

Note that the above embodiment has been described as a form in which when the movable portion 43 moves rotationally about the pin 43c, the movable portion 43 moves between the position shown in FIG. 12(a) and the position shown in FIG. 12(b). However, the present invention is not limited to the above embodiment. The movable portion may move to level off particulate matter by linear movement.

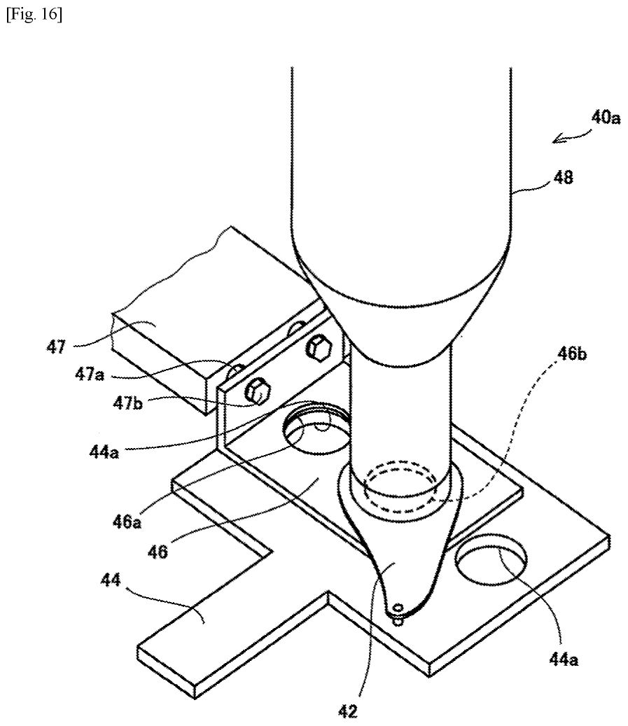

FIG. 15 is an exploded perspective view showing a supply portion 40a of a type in which particulate matter in accommodation regions 46a and 46b are leveled off by linear movement of a movable portion 46.

The supply portion 40a includes a connection portion 44, a level-off portion 42, a container portion 48, the movable portion 46, and a cylinder portion 47. The movable portion 46 is formed in a plate shape, and is bent at approximately 90 degrees to have an L-shaped cross section. Additionally, the movable portion 46 has the two accommodation regions 46a and 46b.

The cylinder portion 47 includes a protrusion 47a protruding from a hole formed in the cylinder portion 47. The protrusion 47a is attached to the cylinder portion 47 so as to protrude toward the movable portion 46 from the cylinder portion 47. In the embodiment, the cylinder portion 47 includes two protrusions 47a. In the embodiment, the protrusion 47a has a columnar shape. Additionally, the hole into which the protrusion 47a is inserted is formed in a cylindrical shape corresponding to the shape of the protrusion 47a.

The protrusion 47a is attached to the movable portion 46 by a bolt 47b. The movable portion 46 has a hole through which the bolt 47b passes. The protrusion 47a is attached to the movable portion 46 by, with the protrusion 47a in contact with the movable portion 46, fastening the bolt 47b to the protrusion 47a through the hole formed in the movable portion 46 from a position of the movable portion 46 on the container portion 48 side.

Additionally, the protrusion 47a is capable of changing the amount of protrusion from the cylinder portion 47. An unillustrated driver is disposed inside the cylinder portion 47, and the driver can be driven to move the protrusion 47a and change the amount of projection from the cylinder portion 47.

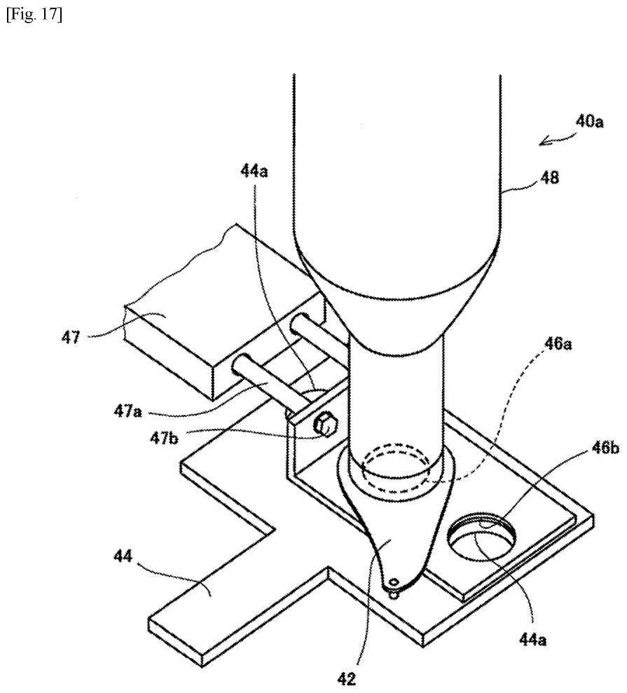

The movable portion 46 in states when the supply portion 40a configured as shown in FIG. 15 is operated will be described with reference to FIG. 16 and FIG. 17.

FIG. 16 shows a state in which the movable portion 46 is positioned on the cylinder portion 47 side. At this time, one accommodation region 46a formed on the cylinder portion 47 side of the movable portion 46 communicates with one discharge port 44a of the discharge ports 44a formed in the connection portion 44 that is formed on the cylinder portion 47 side. Additionally, the accommodation region 46b formed in the other position on the side opposite to the cylinder portion 47 side of the movable portion 46 communicates with the flow path of particulate matter that supplies the particulate matter from the container portion 48 to the level-off portion 42.

In this state, the particulate matter is supplied from the container portion 48 to the inside of the accommodation region 46b formed in the other position on the side opposite to the cylinder portion 47 side of the movable portion 46. Additionally, the particulate matter accommodated in one accommodation region 46a formed on the cylinder portion 47 side of the movable portion 46 is discharged through the discharge port 44a.

When the particulate matter accommodated in one accommodation region 46a formed on the cylinder portion 47 side of the movable portion 46 is discharged from the discharge port 44a and particulate matter is supplied to the accommodation region 46b formed in the other position on the side opposite to the cylinder portion 47 side of the movable portion 46, the movable portion 46 moves to become the state shown in FIG. 17.

The movement of the movable portion 46 is caused by the protrusion 47a protruding from the cylinder portion 47 moving toward the container portion 48 and thereby pushing the movable portion 46. When the protrusion 47a moves in a direction in which a tip end portion of the protrusion 47a separates from the cylinder portion 47, the movable portion 46 is pushed toward the container portion 48 and the movable portion 46 moves in a direction of approaching the container portion 48.

When the movable portion 46 is in the state shown in FIG. 17, the accommodation region 46b formed in the other position on the side opposite to the cylinder portion 47 side of the movable portion 46 communicates with the other discharge port 44a of the discharge ports 44a formed in the connection portion 44 that is formed on the side opposite to the cylinder portion 47. Additionally, the accommodation region 46a formed in one position on the cylinder portion 47 side of the movable portion 46 is in communication with the flow path of particulate matter that supplies the particulate matter from the container portion 48 to the level-off portion 42.

Accordingly, the particulate matter that has been accommodated in the accommodation region 46b formed in the other position on the side opposite to the cylinder portion 47 side of the movable portion 46 in the state shown in FIG. 16 is discharged through the other discharge port 44a formed on the side opposite to the cylinder portion 47. Additionally, particulate matter is supplied from the container portion 48 to the inside of the accommodation region 46a formed in one position on the cylinder portion 47 side of the movable portion 46.

Additionally, when the movable portion 46 moves from the state shown in FIG. 16 to the state shown in FIG. 17, particulate matter accommodated in the accommodation region 46b on the side opposite to the cylinder portion 47 side is leveled off by the level-off portion 42. When the movable portion 46 moves, the accommodation region 46b passes a position below the level-off portion 42, and particulate matter overflowed from an upper opening of the accommodation region 46b and filled up to a position higher than the upper opening of the accommodation region 46b is leveled off by an inner wall surface of the level-off portion 42. Thus, the particulate matter accommodated in the accommodation region 46b is leveled off, and a fixed amount of particulate matter is accommodated in the accommodation region 46b.

When particulate matter is supplied to one accommodation region 46a formed on the cylinder portion 47 side of the movable portion 46 and the particulate matter accommodated in the accommodation region 46b formed in the other position on the side opposite to the cylinder portion 47 side of the movable portion 46 is discharged from the discharge port 44a, the movable portion 46 moves to return to the state shown in FIG. 16.

When the movable portion 46 moves from the state shown in FIG. 17 to the state shown in FIG. 16, as the protrusion 47a moves toward the cylinder portion 47, the movable portion 46 is pulled by the protrusion 47a and the movable portion 46 moves toward the cylinder portion 47. When the protrusion 47a moves in a direction in which the tip end portion of the protrusion 47a approaches the cylinder portion 47, the movable portion 46 is pulled toward the container portion 48 and the movable portion 46 moves in a direction of approaching the cylinder portion 47.

Continuous reciprocation of the movable portion 46 between the position shown in FIG. 16 and the position shown in FIG. 17 enables supply of particulate matter to the inside of the accommodation regions 46a and 46b, leveling off of the particulate matter accommodated in the accommodation regions 46a and 46b, and discharge of particulate matter from the discharge port 44a in a continuous manner.

Since the movement for leveling off particulate matter is performed by the linear movement as described above, a mechanism such as a pin or a link which is has been necessary for causing rotational movement, is no longer necessary. Hence, the configuration of the supply portion 40a can be simplified. Accordingly, the supply portion 40a can be downsized. Additionally, the manufacturing cost of the supply portion 40a can be kept small.

Additionally, in the embodiment, the bolt 47b for attaching the movable portion 46 to the cylinder portion 47 is provided in a position exposed to the outside. Since the bolt 47b is provided in the position exposed to the outside, the bolt 47b can be removed easily. Accordingly, replacement work of the movable portion 46 can be performed easily.

As described above, the movable portion 46 in which the accommodation regions 46a and 46b are formed may be replaced according to the desired supply amount of particulate matter from the discharge port 44a. Additionally, the movable portion 46 in which the accommodation regions 46a and 46b are formed may be replaced according to the desired falling position of particulate matter from the discharge port 44a. In these cases, replacement work for replacing the movable portion 46 is required. At these times, according to the supply portion 40a, replacement work of the movable portion 46 can be performed easily. Accordingly, it is possible to easily adjust the supply amount of particulate matter or change the falling position of particulate matter.

Additionally, since the movable portion 46 can be removed easily, the periphery of the level-off portion 42 can be cleaned easily. Hence, the supply portion 40a with a favorable maintainability can be provided.

Note that In the above embodiment, a description has been given of the type of supply portion 40a in which the container portion 48, the level-off portion 42, and the movable portion 46 are supported on the connection portion 44 and the movable portion 46 moves linearly. However, the present invention is not limited to the above embodiment. The type of supply portion in which the movable portion moves linearly may also be adopted in other types of supply portions. For example, a supply portion may be configured such that a movable portion moves linearly in the type of supply portion as in the first embodiment, in which the fixed plate and the movable portion are accommodated inside the container portion and the bottom portion having the discharge port forms a part of the container portion. Additionally, a configuration in which a movable portion moves linearly may be adopted in a type of supply portion other than the first embodiment or the second embodiment.

### Other Embodiment

In the above embodiment, the configuration has been described in which, by moving the movable portion rotationally, the particulate matter accommodated in the accommodation region is leveled off and the particulate matter that has been leveled off is moved to the discharge port. Additionally, the configuration has been described in which, by moving the movable portion linearly, the particulate matter accommodated in the accommodation region is leveled off and the particulate matter that has been leveled off is moved to the discharge port. However, the present invention is not limited to the above embodiments, and a movement of the movable portion other than the rotational or linear movement may cause the particulate matter accommodated in the accommodation region to be leveled off and cause the particulate matter that has been leveled off to be moved to the discharge port.

Additionally, in the above embodiments, the configuration has been described in which reciprocation of the movable portion enables continuous leveling off of particulate matter and continuous supply of the particulate matter to a box. However, the present invention is not limited to the above embodiments, and the movable portion need not be reciprocated if the leveling off and supply of particulate matter need not be performed continuously.

### REFERENCE SIGNS LIST

30 supply portion

31b bottom portion

31f fixing plate

31j movable portion

31l accommodation region

100 particulate matter supply device body portion

1. A particulate matter supply device comprising:
a first member through which a first flow path that allows passage of particulate matter penetrates;
a second member through which a second flow path that allows passage of particulate matter penetrates; and
a movable member that is disposed between the first member and the second member, has an accommodation region capable of accommodating particulate matter in the accommodation region and penetrating the movable member along a facing direction in which the first member and the second member face each other, and is movable to a first position where the accommodation region communicates with the first flow path and to a second position where the accommodation region communicates with the second flow path, wherein
the first member is provided with a level-off portion that, when the movable member moves from the first position to the second position, levels off particulate matter so as to remove an amount of particulate matter exceeding a capacity of the accommodation region from the accommodation region.

2. The particulate matter supply device according to claim 1, wherein
the movable member is capable of reciprocating between the first position and the second position.

3. The particulate matter supply device according to claim 1, wherein
the movable member moves from the first position to the second position by moving rotationally between the first member and the second member.

4. The particulate matter supply device according to claim 1, wherein
the movable member moves from the first position to the second position by moving linearly between the first member and the second member.

5. The particulate matter supply device according to claim 1 further comprising a first container portion, wherein:
the first member is attached to an inside of the first container portion;
the second member forms a bottom portion of the first container portion; and
the movable member is disposed between the first member and the second member inside the first container portion.

6. The particulate matter supply device according to claim 5 further comprising a shaft portion that passes through the first container portion and is attached to the movable member, wherein
rotation of the shaft portion about a central axis inside the first container portion causes the movable member to move rotationally between the first member and the second member, and moves the movable member from the first position to the second position.

7. The particulate matter supply device according to claim 6 further comprising a first driver that rotates the shaft portion about the central axis, wherein
the first driver rotates the shaft portion about the central axis in forward and reverse directions to cause the movable member to reciprocate between the first position and the second position.

8. The particulate matter supply device according to claim 6, wherein:
the first container portion has a cylindrical portion formed in a cylindrical shape;
the first member is formed in a disk shape along an inner side surface of the cylindrical portion, the first flow path being formed by an arc-shaped notch; and
a level-off portion is formed on a circumferential end of the first member.

9. The particulate matter supply device according to claim 8, wherein
an inclined surface inclined with respect to the vertical direction is formed on the circumferential end of the first member.

10. The particulate matter supply device according to claim 1, wherein:
the second member supports the first member and the movable member;
the first member is attached to the second member in a state where a gap is formed between the first member and the second member; and
the movable member moves from the first position to the second position by moving in the gap.

11. The particulate matter supply device according to claim 10, wherein
two of the second flow paths are formed in the second member.

12. The particulate matter supply device according to claim 10, wherein
two of the accommodation regions are formed in the movable member.

13. The particulate matter supply device according to claim 12, wherein
when the movable member is disposed in a position where the accommodation region on one side of the two accommodation regions communicates with the second flow path on one side of the two second flow paths, the accommodation region on the other side communicates with the first flow path, and when the movable member is disposed in a position where the accommodation region on the other side of the two accommodation regions communicates with the second flow path on the other side of the two second flow paths, the accommodation region on one side communicates with the first flow path.

14. The particulate matter supply device according to claim 10 further comprising a second container portion, wherein
the second container portion and the first member are connected such that a space inside the second container portion communicates with the first flow path of the first member.

15. The particulate matter supply device according to claim 10, wherein
the movable member includes a pin, a plate member capable of moving rotationally about the pin, and a plate portion attached to the plate member and having the accommodation region, and
the plate member and the plate portion are attached by engaging with each other.

16. The particulate matter supply device according to claim 15 further comprising a second driver that moves the plate member rotationally about the pin, wherein
the second driver moves the plate member rotationally in forward and reverse directions to cause the movable member to reciprocate between the first position and the second position.

17. The particulate matter supply device according to claim 1, wherein
a portion of the movable member in which the accommodation region is formed is changeable according to a desired amount of particulate matter falling from the second flow path.

18. The particulate matter supply device according to claim 1, wherein
a portion of the movable member in which the accommodation region is formed is changeable according to a desired falling position of particulate matter falling from the second flow path.

19. The particulate matter supply device according to claim 1, wherein
a supply portion that supplies particulate matter is configured by an arm of a robot.
